(19) United States
(12) Patent Application Publication
(10) Pub. No.: US 2005/0065760 A1
(43) Pub. Date: Mar. 24, 2005

(54) Method for advising patients concerning doses of insulin

(76) Inventors: Robert Murtfeldt, La Canada, CA (US); Robert Campbell, Waltham, MA (US)

Correspondence Address: INSULET CORPORATION, 9 Oak Park Drive, Bedford, MA, 01730, US

(21) Appl. No.: 10/669,062

(22) Filed: Sep. 23, 2003

(51) Int. Cl. G06G 7/48

(52) U.S. Cl. 703/11

(57) ABSTRACT

A method for guiding a user to select a dose of insulin, including the steps of calculating a firsts pecific dose of insulin by applying information provided by the user to an insulin dose calculation algorithm, wherein such information includes at least the user's current blood glucose level and the user's desired blood glucose level, calculating at least a second specific dose of insulin that is different from the first specific dose, and presenting to the user a range of doses comprising at least two of the specific doses.

### FIELD OF THE INVENTION

The present invention relates generally to medical devices, systems and methods, and more particularly to new and improved methods for calculating and suggesting doses of insulin to a user.

### BACKGROUND OF THE INVENTION

For insulin dependent diabetics blood glucose control is achieved through a regimen of blood glucose monitoring and insulin administration. Insulin may be delivered by a variety of means, including subcutaneous injection, infusion pump (external or implanted), inhaled and oral. In every case, proper dosing depends upon accurate blood glucose monitoring and proper calculation of the desired insulin dose. A variety of blood glucose monitoring methods are available or are in development, ranging from commercially available blood sample test strips and continuous, subcutaneous glucose sensors to implantable continuous sensors to non-invasive optical sensors.

Because they more closely approximate a healthy system, ambulatory external infusion pumps currently provide the most effective means of blood glucose control for insulin dependent diabetics, when paired with frequent and accurate blood glucose monitoring. Pumps can be programmed to provide optimal amounts of insulin between meals (basal insulin), as well as to compensate for a patient's carbohydrate (including glucose) intake during meals (bolus insulin).

A diabetes patient's challenge today is to use all of the information and tools available to them, in order to effectively manage their blood glucose within acceptable clinical guidelines. Practicing intensive insulin therapy with an insulin pump requires a patient to diligently measure their blood glucose several times each day, accurately estimate their carbohydrate intake before each meal and snack, and be knowledgeable about how their lifestyle (e.g., illness, exercise, fatigue, stress) can change their sensitivity to insulin. The level of complexity of current insulin pumps, limited blood glucose information to work with, and a lack of management tools to help patients estimate their carbohydrate intake have limited the number of people who can practice pump therapy. Future availability of less complex pumps, glucose sensors that can provide continuous glucose monitoring and carbohydrate databases and calculators promise to make diabetes management simpler, allowing more patients to practice pump therapy and achieve better glycemic control.

The owner of the present application, for example, has developed a small, low cost, light-weight, easy-to-use infusion pump. The device, which is described in detail in co-pending U.S. application Ser. No. 09/943,992, filed on Aug. 31, 2001, includes an exit port, a dispenser for causing fluid from a reservoir to flow to the exit port, a local processor programmed to cause a flow of fluid to the exit port based on flow instructions from a separate, remote controller device, and a wireless receiver connected to the local processor for receiving the flow instructions. To reduce the size, complexity and costs of the device, the device is preferably provided with a housing that is free of user input components, such as a keypad, for providing flow instructions to the local processor. Instead, the user input components are provided in a remote controller device, which is used to remotely program and control the infusion device. A blood glucose monitor or glucose sensor, and a carbohydrate database may be integrated into the remote controller to provide a single system that incorporates both the administration and monitoring aspects of proper blood glucose control.

Regardless of the delivery system and the blood glucose monitoring system, for insulin dependent diabetics to effectively control their blood glucose with insulin, they must regularly calculate appropriate insulin doses. The determination of an appropriate dose of insulin is extremely complex. Known relevant factors include, for example, current blood glucose levels, desired blood glucose levels, the user's insulin sensitivity, anticipated and/or previous exercise levels and duration, recently consumed and/or anticipated carbohydrate intake (taking into consideration the fat and protein contained in the food as well), the type of insulin to be administered, the amount of active insulin remaining from a previous injection or infusion (since last injection), other medications being taken by the user, the time of day, the user's current physical and psychological condition. Variations among individuals compound the complexity of insulin dose calculation, as does the fact that many of the factors are difficult to quantify accurately. Moreover, even if it were possible to do so, it is generally not practical to have a user input data concerning all possible relevant factors each time the user wishes to calculate an insulin dose.

Thus, while many different mathematical algorithms exist to assist diabetes patients with making these calculations, known algorithms are essentially heuristic in nature. That is, known algorithms provide approximations of an ideal dose based on a limited set of imperfect information. These heuristic algorithms may be implemented in computer programs that run on stand-alone PC's, general personal digital assistants (PDA's), and on dedicated insulin delivery system platforms, such as infusion pumps or the remote controller of the infusion system described above. Despite the fact that all such systems can provide only an approximation of an ideal dose based on imperfect information, known insulin dose calculators output a single specific dose as the ideal in any given circumstance. Unfortunately, an output of this type tends to cause the user to abdicate responsibility for the insulin dose calculation to a system that is inherently imperfect particularly in circumstances that are not factored into whatever heuristic is implemented in the user's calculator.

Accordingly, what are needed are new and improved methods for calculating and suggesting insulin doses. In particular, what are needed are new and improved methods for calculating and suggesting insulin doses that assist the user with the complex calculation of a proper dose, but that do not suggest to the user that they are perfectly accurate and can be applied without judgment on the part of the user.

### SUMMARY OF THE INVENTION

The present invention is directed to a method for guiding a user to select a dose of insulin, including the steps of calculating a firsts specific dose of insulin by applying information provided by the user to an insulin dose calculation algorithm, wherein such information includes at least the user's current blood glucose level and the user's desired blood glucose level, calculating at least a second specific dose of insulin that is different from the first specific dose, and presenting to the user a range of doses comprising at least two of the specific doses.

The various aspects of the invention together with additional features and advantages thereof may best be understood by reference to the following detailed descriptions and examples taken in connection with the accompanying illustrated drawings.

### BRIEF DESCRIPTION OF THE DRAWINGS

FIG. 1 is a perspective view of an exemplary embodiment of a fluid delivery device constructed in accordance with the present invention shown secured on a patient, and an exemplary embodiment of a remote controller device constructed in accordance with the present invention being held by the patient for remotely controlling the fluid delivery device;

FIG. 2a is an enlarged top perspective view of the fluid delivery device of FIG. 1;

FIG. 2b is an enlarged bottom perspective view of the fluid delivery device of FIG. 1;

FIG. 3 is an enlarged front elevation view of the remote controller device of FIG. 1; and

FIG. 4 is a flow chart illustrating an exemplary embodiment of a method according to the present invention, for calculating a bolus dose and then suggesting a range of bolus doses for patient selection based on the accuracy of the information used to calculate the bolus dose, wherein the method can be used with the fluid delivery device and the remote controller device of FIG. 1.

### DETAILED DESCRIPTION OF THE EXEMPLARY EMBODIMENTS

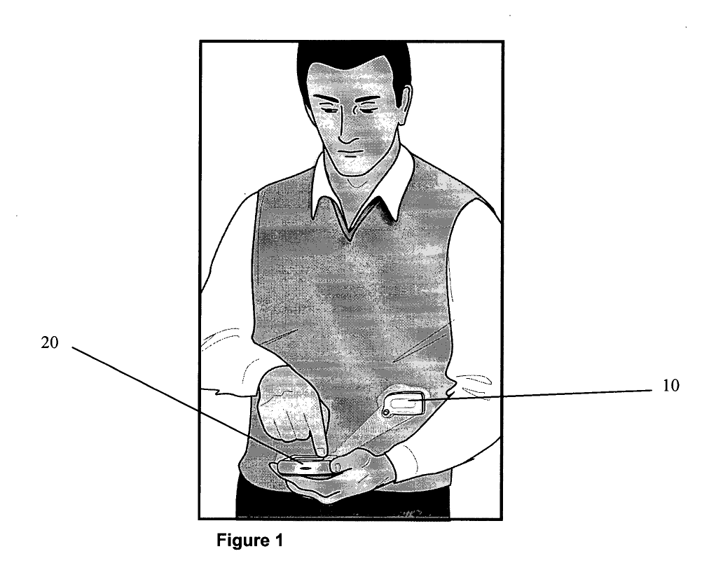

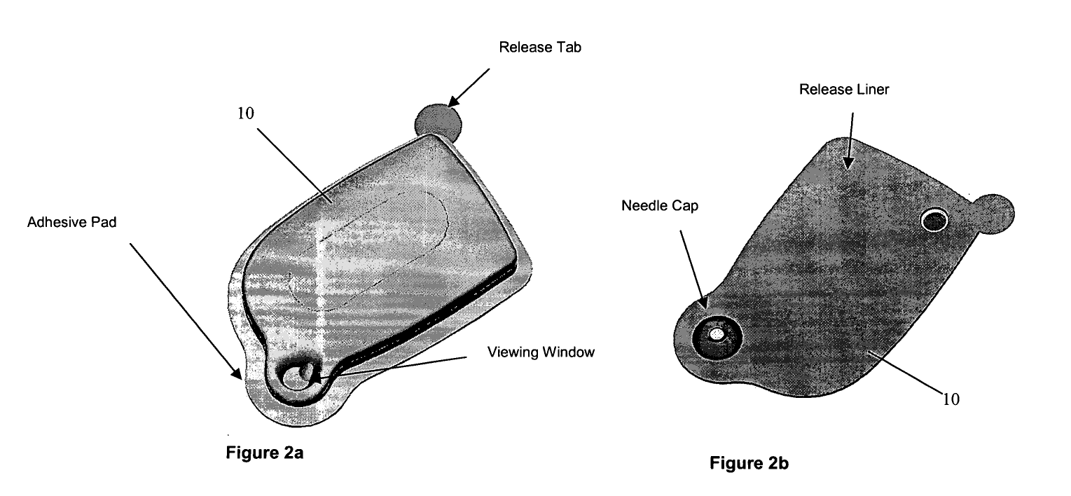

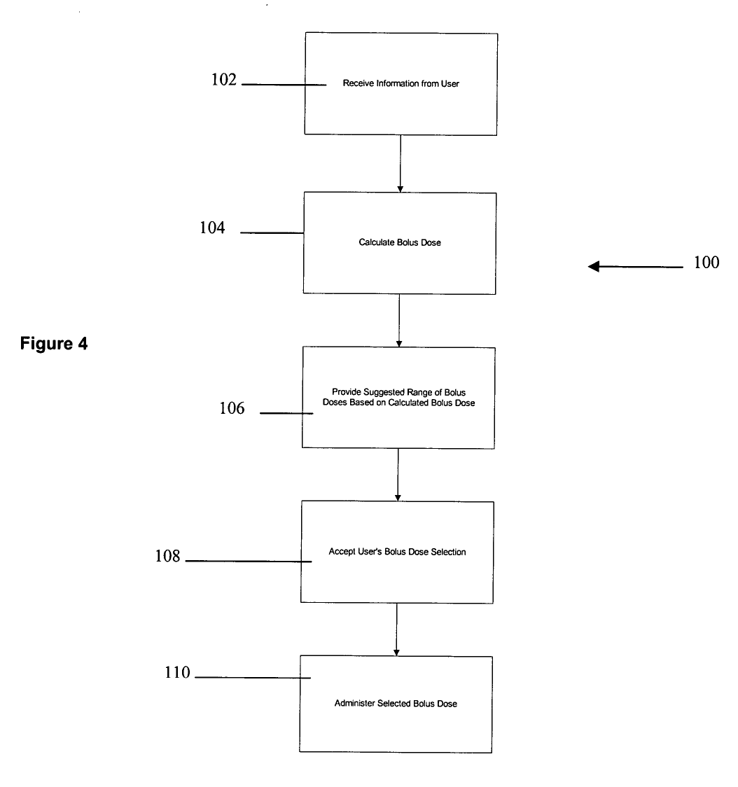

FIGS. 1 through 3 show an exemplary embodiment of system including a fluid delivery device 10 and a remote controller device 20 that can incorporate the new and improved method 100 according to the present disclosure for calculating and suggesting bolus doses, such as the exemplary embodiment shown in FIG. 4. However, it should understood that the method 100 of the present disclosure can be used in other devices, such as other types of medication delivery devices, or infusion devices, and controllers for infusion devices. The new and improved method 100 of the present disclosure can also be provided as a computer program that can be installed and used on devices such as a personal computer, laptop computer, pocket computer, PDA and the like.

Although not shown, the fluid delivery device 10 includes a dispenser including a drive mechanism for causing fluid from a fluid reservoir to flow through a fluid system to a soft cannula insertion system for infusion into a patient. The volume of the reservoir is chosen to best suit the therapeutic application of the fluid delivery device impacted by such factors as available concentrations of medicinal fluids to be delivered, acceptable times between refills or disposal of the fluid delivery device, size constraints and other factors.

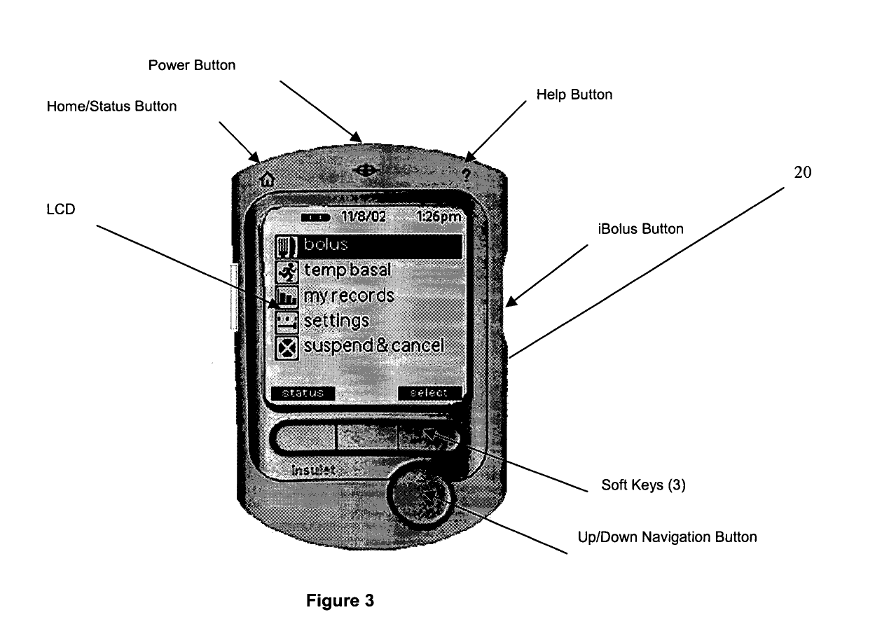

The fluid delivery device 10 includes a processor or electronic microcontroller (hereinafter referred to as the pump controller) connected to the drive mechanism, and is programmed to cause a flow of fluid to the cannula insertion system based on flow instructions from the separate, remote controller device 20 of FIGS. 1 and 3. A wireless receiver is connected to the pump controller for receiving flow instructions from the remote controller device and delivering the flow instructions to the local processor. The device also includes a housing containing the fluid system, the cannula insertion system, the reservoir, the drive mechanism, the pump controller and the wireless receiver.

In order to program, adjust the programming of, or otherwise communicate user inputs to the pump controller, the fluid delivery device 10 includes the wireless communication element, or receiver, for receiving the user inputs from the separate, remote controller device 20 of FIGS. 1 and 3. Signals can be sent via a communication element of the remote controller device.

The remote controller device 20 has user input components, including an array of electromechanical switches, such as “soft keys” buttons, an “Up/Down controller” button, a “user info button”, a “power button”, a “home button”, and an “iBolus™ button”, as shown in FIG. 3. The remote controller device 20 also includes user output components, including a visual display, such as a liquid crystal display (LCD). The remote controller device 20 has its own processor (hereinafter referred to as the “remote” processor) connected to the buttons and the LCD. The remote processor receives the user inputs from the buttons and provides information to the LCD, and then provides control instructions to the fluid delivery device. Since the remote controller device also includes a visual display, the fluid delivery device can be void of an information screen, further reducing the size, complexity and costs of the device.

Referring now to FIGS. 4, the present disclosure provides a new and improved method 100 for guiding a user to select a dose of insulin. The method 100 generally includes receiving information from a patient or other user, as shown at 102, calculating a dose range based on the information, as shown at 104, providing the suggested range of doses to the patient, as shown at 106. The method may further include the steps of accepting the patient's dose selection, as shown at 108, and administering the selected dose, as shown at 110. Significantly, by providing a range of suggested doses instead of a single specific dose, the method of the present disclosure provides the user with guidance as to the optimal dose, but requires the user to exercise judgment in selecting the precise dose to be administered.

The steps of calculating and presenting a range of doses may be accomplished by several different methods. Generally, the first step is to calculate a first specific insulin dose by applying any valid insulin dose calculation algorithm to data that the user has provided. A valid insulin dose calculation algorithm is any medically acceptable method for calculating a specific insulin dose using at least an approximation of current blood glucose level and a desired blood glucose level as inputs. After calculating the first specific insulin dose, the next step is to calculate at least a second specific insulin dose that is different from the first specific dose. The method may further comprise the step of calculating a third specific insulin dose that is different from the second specific dose. Finally the method comprises the step of presenting the user with at least two of the specific insulin doses. The lowest presented dose is the lower dose boundary; the highest presented dose is the higher dose boundary.

In one embodiment, the step of calculating the range of doses comprises the steps of calculating a lower dose boundary by subtracting a first correction factor from the first specific dose and calculating an upper dose boundary by adding a second correction factor to either the first specific dose or to the second specific dose. If the second correction factor is added to the second specific dose (rather than the first specific dose), then the generally (but not necessarily) the second correction factor will be different than the first correction factor. If the second correction factor is added to the first specific dose, then generally (but not necessarily) the first and second correction factors will be identical. This latter method may be represented as follows:
DR1=IDA(user data)−CF1;
DR2=IDA(user data)+CF2;
CF1=CF2;
Wherein
   DR1 is the lower boundary of the dose range;
   DR2 is the upper boundary of the dose range;
   CF1 and CF2 are the correction factors;
   IDA is any valid insulin dose calculation algorithm; and
   user data is whatever IDA takes as inputs.

The correction factor may be as simple as a fixed percentage (or amount) of the calculated optimal insulin dose, or may be complex and adaptive depending upon factors that tend to make the calculated optimal insulin dose more or less accurate. For example, and without limitation, an adaptive correction factor could vary depending upon factors related to the quality of the data inputs, such as, the age of the blood glucose data, the type of blood glucose monitor used, the total number of carbohydrates to be consumed, or the duration and intensity of projected exercise and the user's confidence level and/or proficiency in estimating carbohydrates contained in a meal. Any number of algorithms employing any number of the above factors could be used calculate a correction factor for use in the methods of the present invention. Thus, for example, the correction factor might be relatively small if the user inputs very recent blood glucose data from a high quality sensor and plans to eat a very small meal or a meal where a relatively accurate carbohydrate count is known. On the other hand, if the user provides only a blood glucose level that is relatively old and is from a relatively inaccurate sensor and the user plans to eat a relatively large meal, then the adaptive correction factor might be relatively large. In short, in such a method, the size of the correction factor depends upon the quality of the data available to the insulin dose calculation algorithm. More specifically, one simple example of a method for calculating an adaptive (or fixed) correction factor is to sum the error rate for the blood glucose monitor in use and the user's ingested carbohydrate estimation error to yield a correction factor. In this example, if the blood glucose monitor is accurate to +/−10% and the user's carbohydrate estimation error rate is +/−20%, then the correction factor would be 30% of the calculated optimal dose. Such a rate could be fixed in the system or recalculated adaptively each time the user calculated a new bolus dose.

An alternative method of calculating a dose range using a known insulin dose calculation algorithm would be to apply the known algorithm to two separate target blood glucose levels. Thus, if a user had a target blood glucose range from a minimum blood glucose target to a maximum blood glucose target, an alternative embodiment of the present invention would present the user with an insulin dose range from the result of applying the known algorithm to the minimum blood glucose target to the result of applying the known algorithm to the maximum blood glucose target. This dose range calculation algorithm may be represented as follows:
DR1=IDA(user data, min blood glucose target);
DR2=IDA(user data, max blood glucose target);
Wherein
   DR1 is the lower boundary of the dose range;
   DR2 is the upper boundary of the dose range;
   IDA is any valid insulin dose calculation algorithm; and
   user data is whatever IDA takes as a first input.

The suggested range of doses could be presented in many different ways, such as a text range, or graphically as a curve or as a series of bar graphs, or as a combination of these or other graphical and textual representations of the calculated range. The user could select a dose from among these ranges or even choose a dose outside these ranges by any suitable user interface means.

Thus, the present disclosure provides methods for calculating and suggesting a range of insulin doses. The methods of the present invention can be provided in one or more sequences of instructions carried on a computer-readable medium and executable by one or more processors. The specific methods described in this specification, however, have been presented by way of illustration rather than limitation, and various modifications, combinations and substitutions may be effected by those skilled in the art without departure either in spirit or scope from this disclosure in its broader aspects.

1. A method for guiding a user to select a dose of insulin, comprising the steps of:
a. calculating a first specific dose of insulin by applying information provided by the user to an insulin dose calculation algorithm, wherein such information includes at least the user's current blood glucose level and the user's desired blood glucose level;
b. calculating at least a second specific dose of insulin that is different from the first specific dose;
c. presenting to the user a range of doses comprising at least two of the specific doses.

2. The method of claim 1, further comprising the step of calculating at least a third specific dose of insulin that is different from the second dose of insulin and wherein the range of doses comprises the second and third specific doses.

3. The method of claim 2, wherein the step of calculating the second specific dose comprises the step of subtracting a first correction factor from the first specific dose;

4. The method of claim 3, wherein the step of calculating the third specific dose comprises the step of adding a second correction factor to the specific dose;

5. The method of claim 4, wherein the first and second correction factors are identical.

6. The method of claim 4, wherein the first and second correction factors are different.

7. The method of claim 4, wherein at least one of the first and second correction factors is a predetermined percentage of the specific dose.

8. The method of claim 7, wherein the user information includes a blood glucose value detected by a blood glucose monitor and the percentage is the error rate of the blood glucose monitor.

9. The method of claim 6, wherein the user information further includes at least one of, the age of the most recent blood glucose test, the type of blood glucose sensor used to detect blood glucose, an amount of carbohydrates the user expects to ingest in the immediate future, the duration and intensity of exercise in which the user intends to engage in the immediate future and at least one of the first and second correction factors is variable dependent upon at least one aspect of the user information.

10. The method of claim 1, wherein
the user's desired blood glucose level is defined as a range of blood glucose levels from a lower blood glucose boundary to an upper blood glucose boundary;
the step of calculating the first specific dose of insulin comprises the step of using the lower blood glucose boundary as the desired blood glucose level;
the step of calculating the second specific dose of insulin comprises the step of using the upper blood glucose boundary as the desired blood glucose level.

11. The method of claim 7, wherein the user information includes a blood glucose value detected by a blood glucose monitor and the percentage is the error rate of the blood glucose monitor plus the user's ingested carbohydrate estimation error rate.
